(19) United States
(12) Patent Application Publication
(10) Pub. No.: US 2012/0308871 A1
(43) Pub. Date: Dec. 6, 2012

(54) PRODUCTION AND USE OF CERAMIC COMPOSITE MATERIALS BASED ON A POLYMERIC CARRIER FILM

(75) Inventors: Matthias PASCALY, Muenster (DE); Christian Hying, Rhede (DE); Gerhard Hörpel, Nottuln (DE); Volker Hennige, Graz (AT)

(73) Assignee: Evonik Litarion GmbH, Kamenz (DE)

(21) Appl. No.: 13/523,620

(22) Filed: Jun. 14, 2012

Related U.S. Application Data
(63) Continuation of application No. 13/266,940.

(30) Foreign Application Priority Data
Apr. 28, 2009 (DE) 10 2009 002 680.0

(51) Int. Cl. H01M 2/16; H01G 9/00; B32B 18/00; B05D 3/12; H01M 10/04; B32B 3/24

(52) U.S. Cl. 429/144; 29/623.1; 428/138; 428/140; 427/290; 361/500

(57) ABSTRACT

The invention relates to a ceramic composite material (1), comprising a planar carrier substrate (2) and a porous coating (4) that is applied onto the carrier substrate (2) and contains ceramic particles (3). The problem underlying the invention is that of further developing a ceramic composite material of type such that lower thicknesses can be achieved while maintaining the high thermal and mechanical stability. Said problem is solved by a ceramic composite material having a polymeric film (2) as the carrier substrate (2), wherein the carrier substrate (2) is provided with a perforation that consists of a plurality of holes (6) arranged at regular intervals, and wherein the perforation is covered by the porous coating (4) at least on one side of the carrier substrate (2). A cross-section of the ceramic composite material according to the invention is shown in FIG. 1.

The present invention relates to a ceramic composite material comprising a flat carrier substrate and a porous coating which comprises ceramic particles and has been applied to the carrier substrate. The invention further relates to a process for producing such a ceramic composite material, and to an electrochemical cell which comprises such a ceramic composite material.

In the context of the present application, the term “electrochemical cell” is understood to mean an electrochemical energy store which may be either rechargeable or non-rechargeable. In this respect, the application text does not distinguish between the terms “accumulator/secondary battery” on the one hand, and “battery/primary battery” on the other hand. The term “electrochemical cell” in the context of the application also covers a capacitor. An electrochemical cell is additionally understood to be the minimum functioning unit of the energy store. In industrial practice, a multitude of electrochemical cells is frequently connected in series or parallel in order to increase the total energy capacity of the store. In this context, reference is made to multiple cells. An industrially designed battery may consequently have a single electrochemical cell or a multitude of electrochemical cells connected in parallel or in series. Since this is not relevant to the present invention, the terms “battery” and “electrochemical cell” are used synonymously henceforth.

With regard to the character of a battery, a distinction is made between high-performance batteries and high-energy batteries. A high-performance battery is a store which releases its electrical energy within a particularly short time; it develops high discharge currents. A high-energy battery has a particularly high storage capacity based on its weight or its volume.

The electrochemical cell as an elementary functioning unit comprises two electrodes of opposing polarity, namely the negative anode and the positive cathode. The two electrodes are insulated from one another to prevent short circuits by the separator arranged between the electrodes. The cell is filled with an electrolyte—i.e. an ion conductor which is liquid, in gel form or occasionally solid. The separator is ion-pervious and thus permits exchange of ions between anode and cathode in the charge or discharge cycle.

A separator is conventionally a thin, porous, electrically insulating substance with high ion perviosity, good mechanical strength and long-term stability with respect to the chemicals and solvents used in the system, for example in the electrolyte of the electrochemical cell. In electrochemical cells, it should completely electrically insulate the cathode from the anode. In addition, it must be permanently elastic and follow the movements in the system which arise not only from external loads but also from “breathing” of the electrodes as the ions are incorporated and discharged.

The separator is crucial in determining the lifetime and the safety of an electrochemical cell. The development of rechargeable electrochemical cells or batteries is therefore being influenced to a crucial degree by the development of suitable separator materials. General information about electrical separators and batteries can be found, for example, in J. O. Besenhard in “Handbook of Battery Materials” (VCH-Verlag, Weinheim 1999).

High-energy batteries are used in various applications in which it is important to have available a maximum amount of electrical energy. High-energy batteries are used to drive vehicles (traction batteries), in off-grid, stationary power supply with the aid of batteries (auxiliary power systems), in uninterrupted power supply, in the provision of balancing energy, for portable electronic appliances such as laptops, cellphones and cameras, and for power tools. The energy density is frequently reported in weight-based [Wh/kg] or in volume-based [Wh/l] parameters. At present, energy densities of 350 to 400 Wh/l and of 150 to 200 Wh/kg are being achieved in high-energy batteries. The power required in such batteries is not so great, and so compromises can be made with regard to the internal resistance. This means that the conductivity of the electrolyte-filled separator, for example, need not be as great as in the case of high-performance batteries, and so other separator designs also become possible as a result.

For instance, in the case of high-energy systems, it is also possible to use polymer electrolytes which have quite a low conductivity at 0.1 to 2 mS/cm. Such polymer electrolyte cells cannot, however, be used as high-performance batteries.

Separators for use in high-performance battery systems must have the following properties: they must be very thin in order to ensure a low specific space requirement, and in order to minimize the internal resistance. In order to ensure these low internal resistances, it is important that the separator also has a high porosity, since a high porosity promotes ion perviosity. Moreover, separators must be light in order that a low specific weight is achieved. In addition, the wettability for electrolyte must be high since electrolyte-free dead zones which increase the internal resistance otherwise form.

In many applications, in particular mobile applications, very large amounts of energy are required (for example in traction batteries for fully electric vehicles). The batteries in these applications store, in the fully charged state, a large amount of energy which must not be released in an uncontrolled manner in the event of a malfunction of the battery, for example overcharging or short-circuit, or in the event of an accident, since this would inevitably lead to an explosion and fire in the cell and vehicle. Separators for mobile applications therefore have to be particularly safe in order that the battery of a vehicle involved in an accident does not explode. Rechargeable high-performance batteries and high-energy batteries are nowadays based on lithium ions. Since lithium is a highly reactive metal and the components of a lithium ion accumulator are readily combustible, modern lithium ion or lithium metal batteries or accumulators are hermetically encapsulated. Such battery cells are sensitive to mechanical damage, which can lead, for example, to internal short circuits. An internal short circuit in contact with air can cause lithium ion batteries or lithium metal batteries to ignite. Owing to their exceptionally high storage capacity with comparatively small space requirement, battery cells based on lithium ions are particularly suitable for the production of batteries for electrical vehicles. The incorporation of batteries into vehicles therefore places particular demands on the protection of the battery cells from mechanical and thermal damage.

It is easy to imagine that, for electrical vehicles, there is a need to provide batteries which have a comparatively high storage capacity and a comparatively high terminal voltage. Especially for the automotive industry, for example for fully electrical vehicles, the battery cells must be correspondingly large and, due to the high specific weight of the electrodes, have a high absolute weight. As already mentioned above, battery cells based on lithium ions or lithium metal, for example, are mechanically sensitive, and so particular measures have to be taken in the case of installation into a motor vehicle in order to protect the battery cells from mechanical damage. In the case of a modern passenger vehicle, normal operating cycles are expected to give acceleration forces of two to three times the acceleration due to gravity in any spatial axis. Such forces act on the vehicle in the course of acceleration, deceleration, cornering, and traveling over uneven surfaces. Furthermore, it is absolutely necessary to safeguard a battery installed in a motor vehicle from impact-related mechanical effects and from impact-related acceleration forces. Moreover, the batteries and hence the battery cells and the bonds therefor are exposed to vehicle-related vibrations.

These boundary conditions make high demands on the separator; it must solve the target conflict between high ion conductivity and low weight on the one hand, and high mechanical/thermal stability on the other hand.

With regard to their material, the separators currently being used can be divided into three classes: fully organic separators, fully ceramic separators and organic/inorganic composite separators.

With regard to the structure thereof, there exist two different separator types: textile separators and layer separators. The textile structure generally comprises nonwovens. Nonwovens form part of the class of the textile fabrics and are, according to ISO 9092:1988, defined as sheets, webs or batts of directionally or randomly orientated fibers, bonded by friction or cohesion or adhesion. Textile separators can be imagined as being similar to a felt. The interstices between the fibers thereof give rise to their porosity. Layer separators take the form of sheets or films and are of homogeneous structure. Their porosity arises from a multitude of pores or cavities arranged in an unordered manner in the solid material, similarly to a sponge.

In order to obtain a comparatively flexible separator in spite of the low elasticity of the ceramic materials, fully ceramic separators generally have a textile structure. They consist of inorganic nonwovens, for example nonwovens made of glass or ceramic materials, or else ceramic papers. These are produced by various companies. Important manufacturers here are: Binzer, Mitsubishi, Daramic and others.

The separators made of inorganic nonwovens or of ceramic paper are of very low mechanical stability and lead easily to short circuits, and so no great service life can be achieved.

Fully organic separators find use both in textile structure and in layer structure. Typical organic-based textile separators consist, for example, of polypropylene fibers. The companies Celgard, Tonen, Ube and Asahi produce fully organic separators. Mention is made by way of example of the fully organic layer separator produced by Celgard, LLC under the name Celgard® 2320. This is a three-layer, microporous laminate composed of polypropylene, polyethylene and polypropylene. The term “microporosity” originates from the classification of the pore size of materials, which is effected according to IUPAC. This divides the pore size into the three following groups: for instance, microporous materials contain pores having a size of less than 2 nm. Pores having a size between 2 and 50 nm are found in mesoporous materials. Materials having pores larger than 50 nm are defined as macroporous.

A great disadvantage of organic polyolefin separators is the low thermal durability thereof, which is below 170° C. Even brief attainment of the melting point of these polymers leads to substantial melting of the separator and to a short circuit in the electrochemical cell which uses such a separator. The use of such separators is therefore generally unsafe. This is because these separators are destroyed on attainment of relatively high temperatures, especially of more than 150° C. or even 180° C.

Fully organic separators are therefore unsuitable for use in high-energy or high-performance batteries. For this purpose, fully ceramic or organic/inorganic composite separators are required. With regard to the mechanical properties thereof, the organic/inorganic composite separators are superior to the fully ceramic separators and are therefore used especially in mobile applications.

Organic/inorganic composite separators are described, for example, in DE 102 08 277, DE 103 47 569, DE 103 47 566 or DE 103 47 567. To produce these separators, a suspension of inorganic material is applied to an organic carrier substrate in the form of a PET nonwoven. The porosity of the substrate therefore arises from its textile structure. The pore distribution in the substrate is determined by the textile production process and is unordered. Crosslinking of inorganic binders fixes the ceramic on the nonwoven. Such separators are sold by Evonik Degussa GmbH under the SEPARION® product name.

Another process for producing organic/inorganic composite separators is described in documents WO 02/15299 and WO 02/071509. This involves applying a suspension of an inorganic material composed of a polymeric material. The suspension in this case is based on an organic solvent; organic binders, especially fluorinated polymers, for example polyvinylidene fluoride (PVdF), or fluorinated copolymers, for example polyvinylidene fluoride-hexafluoropropylene copolymer (PVdF-co-HFP), are used. The presence of ceramic constituents in the separators increases the safety thereof, since complete destruction of the separator is prevented by the ceramic even at temperatures exceeding 200° C. The pore size of the resulting separators is influenced essentially by an additional stretching operation which follows the coating of the polymeric carrier material. There is the risk here that stretching at ambient pressure will form large pores or cracks which cannot be closed again. In the case of stretching under pressure at high temperature, even the smallest pores can be closed again by filling with polymer. A homogeneous pore size distribution consequently cannot be achieved by this process.

DE 103 43 535 B3 discloses a separator for a lithium polymer battery, which is provided with a defined surface profile. This is accomplished in the course of the production operation with the aid of rollers. The rollers disclosed are, for example, knurled or pimpled. This imparts a regular surface structure to the separator, the surface structure consisting of crater-like depressions or elevations. The entirety of the separator is profiled, such that the crater-like depressions or elevations remain uncovered in the surface.

EP 1 038 329 B1 and U.S. Pat. No. 6,432,576 B1 disclose a lithium accumulator, the separator of which has been provided with a defined structure of holes. Both electrodes have corresponding hole patterns; the layers are stacked with aligned holes. Bridges of polymeric material which flanks the electrodes on the outside extend through the aligned holes. The polymeric material which reaches through the holes is consequently not part of the separator, but rather constitutes the envelope of the cell.

DE 199 21 955 A1 discloses a regularly perforated separator for lead-acid batteries. The perforation is formed by passages which serve for gas exchange in the cell. The separator described therein consists of a textile material or microporous powder; no ceramic coating is evident. For safety reasons, such perforated separators can never be used for lithium cells with high energy density: this is because the open holes within the separator promote the formation of dendrites which short-circuit the electrodes and easily destroy the cell. In order to prevent this, DE 199 21 955 A1 teaches the addition of alkali metal sulfate such as Na₂SO₄ to the electrolyte, since this salt allegedly prevents too high a concentration of lead ions at the end of the discharge. However, this teaching cannot be applied to the cell chemistry of a lithium ion battery. There is therefore a risk that the dendrites will penetrate the passages of the separator disclosed in DE 199 21 955 A1 and lead to a fatal short circuit. Due to the much higher energy density of lithium batteries used especially in automotive applications, the regularly perforated separator disclosed here is completely unsuitable.

WO 06/068428 A1 discloses a separator which is suitable for a lithium battery with high energy density. This is an organic/inorganic composite separator which consists of a polyolefinic carrier substrate and a porous coating which comprises ceramic particles and has been applied thereto. The carrier substrate may be in the form of fibers or present as a membrane. A carrier substrate in the form of fibers is understood by the person skilled in the art to mean a textile fabric, especially a nonwoven. It is not clear from the publication what should be understood by a membrane; possibly, the term “membrane” does not refer to a further embodiment of the carrier structure, but is used synonymously for the same textile structure formed from fibers. This becomes clear from the fact that known microfiltration membranes are generally configured as textile fabrics. Whatever the carrier structure according to this teaching, it is porous and has a homogeneous but unordered pore distribution. The separator disclosed can become very thin; it has a preferred thickness of 1 to 30 μm, and the minimum thickness of the substrate should be 1 better 5 μm. The publication points out that, given these low material thicknesses, no great porosity can be achieved since the mechanical stability of the separator would otherwise be impaired. The limited porosity in turn limits the ion perviosity of the separator and hence ultimately the power released by the cell formed with the separator. This is a disadvantage of the organic/inorganic composite separator disclosed in WO 06/068428 A1.

WO 06/004366 A1 likewise discloses a composite separator with an organic carrier substrate and an inorganic coating applied thereto. Just like the coating, the carrier substrate has unordered pores; the coating is anchored in the carrier substrate. Otherwise, the statements made above apply to this separator.

WO 06/025662 A1 discloses, in one working example, a porous organic/inorganic composite separator which has a homogeneous structure without the use of a carrier substrate. For this purpose, ceramic particles are bonded to a polymeric binder. Such homogeneous separators can attain very low thicknesses, but the mechanical stability thereof leaves something to be desired. Further working examples are similar to the subjects of WO 06/004366 A1 and of WO 06/068428 A1.

WO 08/097,013 A1 likewise discloses a separator with a polyolefinic porous carrier substrate and a coating which has ceramic particles and has been applied to at least one side thereof. The carrier substrate may be a membrane. The pores are in unordered distribution in the carrier substrate.

Separators manufactured in practice nowadays have at least a thickness of approx. 20 μm. In principle, it is desirable to obtain very thin separators. As a result, the proportion of the constituents of a battery which do not contribute to the activity thereof can firstly be reduced. Secondly, the reduction in the thickness simultaneously brings about an increase in the ion conductivity. The low wall thickness, however, lowers the mechanical stability and hence safety.

The best solution to this target conflict in the field of high-energy/high-performance batteries has been considered to date to be that of organic/inorganic composite separators which have a flat, textile-organic carrier substrate and a porous-ceramic coating applied thereto. Examples thereof are the above-mentioned SEPARION® products or the subject matter of WO 06/068428 A1. Both can be considered here to constitute the generic type.

Here and hereinafter, the term ceramic composite material is used for the term separator.

Proceeding from the prior art outlined above, it is an object of the invention to develop a ceramic composite material of the generic type specified at the outset, while retaining the high thermal and mechanical stability thereof, such that it attains lower thicknesses.

This object is achieved by providing a polymer film as the carrier substrate, said carrier substrate being provided with a perforation which consists of a multitude of regularly arranged holes, and said perforation being covered by the porous coating at least on one side of the carrier substrate.

The invention therefore provides a ceramic composite material which comprises a flat carrier substrate and a porous coating which comprises ceramic particles and has been applied to the carrier substrate, the carrier substrate thereof being a polymer film which has been provided with a perforation which consists of a multitude of regularly arranged holes, said perforation being covered by the porous coating at least on one side of the carrier substrate.

A basic idea of the present invention is to use, as the carrier substrate, a polymer film whose ion perviosity arises from the introduction of controlled perforation into an intrinsically ion-impervious, continuous original film in accordance with a defined geometric pattern, said perforation having rendered the film ion-pervious. Consequently, in accordance with the invention, a homogeneously perforated film is used, the ion perviosity of which is constant over the entire area of the film due to the regularity of the perforation pattern.

This has the crucial advantage that the mechanical weakening of the film caused by the perforation is constant over the entire area thereof, just like the ion perviosity thereof. The invariable weakening permits the thickness of the film to be minimized to just the degree required for the necessary load-bearing capacity of the polymer film: for the lack of a random distribution of porosity, there is likewise no random distribution of load-bearing capacity, and so the great safety margins in the dimensioning of the film thickness are no longer necessary.

Indeed, it is found that inventive ceramic composite materials based on a regularly perforated polymer film as a carrier substrate, for the same thermal and mechanical stability, achieve much lower total thicknesses than conventional organic/inorganic composite separators based on textile carrier substrate.

Compared to separators which are obtained by stretching a film, the inventive ceramic composite materials have the advantage that it is possible to dispense with the process step of stretching. A further advantage is that the pore size of the ceramic composite material can be adjusted relatively exactly via the particle size used, whereas the pore size in the case of the ceramic composite materials produced by stretching depends on the stretching operation. A further advantage is that the porosity of the ceramic composite material can be modified not solely through the coating material but also through the perforation of the perforated film: the hole density and hole size can be defined exactly. In the case of use of the perforated films as a carrier substrate, a further advantage is that the thickness of the film can be adjusted in a very variable manner. Preference is given to using films with a thickness of at least 1 μm. In contrast to the polyolefin film, the present ceramic composite material additionally has advantageously good wetting of the surface by battery electrolytes. Use of film as a support material and ceramic as a coating material combines the advantages of the ceramic separator types (high porosity, ideal pore size, low thickness, low basis weight, very good wetting characteristics, high safety) with those of the polymeric separator types (low basis weight, low thickness, high foldability/bendability).

Advantageously, the holes are essentially round, and the distance between the centers of two adjacent holes is selected in such a way that it is constant within the perforation. Observing these geometric specifications leads to a particularly regularly perforated ceramic composite material which meets the highest expectations with regard to the constancy of ion perviosity. “Round” in this context means circular or elliptical or oval. However, a circular hole cross section is preferred since circular holes, due to their ideal symmetry, provide high regularity and are easy to produce industrially. It is, however, equally conceivable to select hole cross sections which achieve a lower degree of symmetry, such as ovals or elliptical holes, or holes whose cross section is described by a regular polygon.

The inventive ceramic composite material may have the coating only on one side of the polymer substrate or on both sides of the polymer substrate and in the holes. The inventive ceramic composite material preferably has the coating on both sides of the polymer substrate and in the holes. Therefore, the coating is applied to both sides of the carrier substrate, such that it the coating reaches through the holes. This increases the durability of the ceramic composite material and improves the homogeneity thereof. This embodiment also has the advantage that, in the case of use of the ceramic composite material for separation of anode and cathode, the coating in each case is in contact with the cathode or anode material.

The ceramic particles of the coating are preferably bonded to one another by means of an inorganic binder. The binder increases the integrity of the coating and hence the mechanical strength. The use of an inorganic binder has a positive influence on the thermal stability of the ceramic composite material.

Suitable inorganic binders are silanes, i.e. compounds formed from silicon and hydrogen.

Alternatively, it is possible to use an organic binder to bond the ceramic particles of the coating to one another. The use of an organic binder has a positive effect on the flexibility of the ceramic composite material: for instance, the ceramic composite material comprising organically bound particles is notable for improved bendability and higher folding tolerance compared to those separators whose ceramic particles are bound by means of inorganic binders. It is advantageous here that the ceramic particles are not crosslinked by means of another ceramic, and this task is instead assumed by the polymeric organic binder. The polymer is much more flexible over a wide temperature range compared to the ceramic. A further advantage of the organically bound ceramic composite material is that much less ceramic dust occurs in the course of cutting than in the course of cutting of conventional ceramic separators.

A further advantage of the organic binder is that it is capable of bonding not only the ceramic particles to one another but also the ceramic particles to the polymer film. As a result, the adhesion of the coating on the carrier substrate is enhanced, and so the coating is not damaged in the course of incorporation of the finished ceramic composite material into the cell. Preference is therefore given to an embodiment in which the organic binder bonds at least some of the ceramic particles of the coating to the polymer film.

The organic binder present in the inventive ceramic composite material may, for example, be a polymer or a copolymer, preferably a fluorinated polymer or copolymer. The inventive ceramic composite material preferably comprises, as a fluorinated organic binder, at least one compound selected from polyvinylidene fluoride, polyvinylidene fluoride-hexafluoropropylene copolymer or polyvinylidene fluoride-chlorotrifluoro-ethylene copolymer. More preferably, the fluorinated polymer present in the inventive ceramic composite material is polyvinylidene fluoride, or the copolymer present is a polyvinylidene fluoride-hexafluoro-propylene copolymer. A suitable organic binder is the polyvinylidene fluoride-hexafluoropropylene copolymer obtainable under the name Kynar Flex® 2801 from Arkema.

The polymer substrates present may especially be films of those polymers or copolymers which preferably have a melting point of greater than 100° C., especially greater than 130° C. and more preferably greater than 150° C. The films present as the polymer substrate in the ceramic composite material are preferably those of polymer having a crystallinity of 20 to 95%, preferably of 40 to 80%. Particular preference is given to using films of at least one of the following polymers as the carrier substrate:

a) polyethylene terephthalate,
b) polyacrylonitrile,
c) polyester,
d) polyamide,
e) aromatic polyamide (aramid),
f) polyolefin,
g) polytetrafluoroethylene,
h) polystyrene,
i) polycarbonate,
k) acrylonitrile-butadiene-styrene,
l) cellulose hydrate.

Suitable unperforated original films can be purchased, for example, from DTF (DuPont-Teijin-Films).

Such polymer films are produced in a manner known per se by flat or tubular extrusion, or by casting from solutions. In this way, a continuous original film is obtained, which has to be perforated. A suitable laser-supported process for perforation of the continuous polymer film is described in U.S. Pat. No. 7,083,837. Also suitable is the process filed by GR Advanced Materials Limited under the title “Microperforated Film” at the British Patent Office at the same date as the present application. In this respect, reference is made to the teaching of these publications.

It may be advantageous when the polymer film has a thickness of less than 25 preferably less than 15 μm and more preferably of 1 to 15 μm. As a result of the very low thickness of the carrier substrate, it is possible to achieve a thickness of less than 25 μm for the overall ceramic composite material. Preferred inventive ceramic composite materials have a thickness of less than 25 μm, especially a thickness of 4 to 20 μm. The thickness of the ceramic composite material has a great influence on the properties thereof, since firstly the flexibility, but secondly also the areal resistance, of the electrolyte-impregnated ceramic composite material depends on the thickness of the ceramic composite material. The low thickness achieves a particularly low electrical resistance of the ceramic composite material in the application with an electrolyte. The ceramic composite material itself naturally has a very high electrical resistance since it must itself have insulating properties. In addition, relatively thin ceramic composite materials allow an increased packing density in a battery stack, such that a greater amount of energy can be stored in the same volume.

The carrier substrate, which is a perforated film, preferably has holes having a diameter of less than 500 μm, preferably less than 300 μm and more preferably of 40 to 150 μm. If the cross-sectional geometry of the holes differs from the preferred circular form, the aforementioned diameter is in each case understood to mean the maximum dimension of the hole, i.e. the diameter of the circle.

The perforated film preferably has a sufficient number of holes and sufficiently large holes that the proportion of the holes in the total area of the polymer film is 10 to 90%. The polymer substrate thus has a perforated area of 10-90%, which means that the sum of the cross-sectional area of the individual holes amounts to 10 to 90% of the total area of the within the outline of the carrier substrate. The polymer substrate preferably has a perforated area of 10 to 80%, more preferably of 20 to 75%.

In the case of homogeneous and regular distribution of circular holes with a uniform diameter in the film, the hole density in ppi (pores per inch) can be reported. The selection of the hole diameter and of the distance between the individual holes determines the hole density. Further details on this subject are described in the working examples.

It may be advantageous when the polymer substrate has the holes with a density greater than 30 ppi, preferably greater than 40 ppi and more preferably of 50 to 700 ppi. By virtue of a sufficiently large number of holes per unit area, a sufficiently great porosity of the substrate is obtained, such that the substrate itself offers minimum resistance to the ion conduction.

The ceramic particles present in the coating of the inventive ceramic composite material preferably have a mean particle size d₅₀ of 0.01 to 10 μm, preferably of 0.1 to 8 μm and more preferably of 0.1 to 5 μm. The mean particle size of the ceramic particles can be determined by means of small angle laser scattering in the course of production of the ceramic composite material, or by removing the polymeric constituents of the ceramic composite material, for example by dissolving the polymers to detach them from the ceramic particles.

It may be advantageous when the ceramic particles have a maximum particle size of 10 μm, preferably of less than 10 μm and more preferably of less than 7.5 μm. The restriction in the maximum particle size can ensure that the ceramic composite material does not exceed a particular thickness. The maximum particle size and the particle size distribution can be determined, for example, by laser scattering or as the filter residue of an appropriate test sieve.

The ceramic particles present in the ceramic composite material may in principle be any ceramic particles which are electrically nonconductive. Present with preference in the ceramic composite material are ceramic particles selected from the oxides of magnesium, silicon, boron, aluminum and zirconium, or mixtures thereof. The ceramic particles are preferably oxide particles of magnesium, barium, boron, aluminum, zirconium, titanium, hafnium, zinc, silicon, or mixed oxides of these metals, especially B₂O₃, Al₂O₃, ZrO₂, BaTiO₃, ZnO, MgO, TiO₂ and SiO₂.

The inventive ceramic composite materials can be bent without any damage, preferably to any radius down to 100 mm, preferably to a radius of 100 mm down to 50 mm and most preferably to a radius of 50 mm down to 0.5 mm. The inventive ceramic composite material also withstands folding without any damage. The inventive ceramic composite materials are also notable in that they preferably have a breaking strength (measured with a Zwick tensile tester; according to method ASTM D882) of at least 1 N/cm, preferably of at least 3 N/cm and most preferably of greater than 5 N/cm. The high breaking strength and the good bendability of the inventive ceramic composite material have the advantage that changes in the geometries of the electrodes which occur in the course of charging and discharging of a battery can be followed by the ceramic composite material without damage to the latter. The bendability additionally has the advantage that this ceramic composite material can be used to produce commercial standard wound cells. In these cells, the electrodes/ceramic composite material layers in standard size are spiral-wound and contacted with one another.

Preferably, the inventive ceramic composite material has a porosity of 30 to 60%, preferably of 40 to 50%. The porosity is based on the pores that can be reached, i.e. are open. The porosity can be determined by means of the known method of mercury porosimetry (based on DIN 66 133).

The inventive ceramic composite material can be produced in various ways. The inventive ceramic composite material is preferably obtainable by the process according to the invention described hereinafter, or is obtained by a process comprising the following steps:
a) providing a continuous polymer film,
b) perforating the polymer film such that the polymer film receives a perforation consisting of a multitude of holes in regular arrangement,
c) applying a porous coating comprising ceramic particles to at least one side of the perforated polymer film.

The invention consequently also provides a process for producing a ceramic composite material, comprising the steps just detailed.

The coating is preferably applied to the perforated polymer film by applying a dispersion to the perforated polymer film and consolidating it, said dispersion dispersing ceramic particles in a solution, and said solution comprising a preferably fluorinated organic binder dissolved in an organic solvent. In addition, the dispersion preferably comprises an acid such as HNO₃. Dispersions in the context of the invention are also slips.

Preference is given to using a dispersion which has a proportion of ceramic particles in the overall dispersion of 10 to 60% by mass, preferably of 15 to 40% by mass and more preferably of 20 to 30% by mass.

In relation to the binder, preference is given to using a dispersion which has a proportion of preferably fluorinated organic binder of 0.5 to 20% by mass, preferably of 1 to 10% by mass and more preferably of 1 to 5% by mass.

For production of the dispersion, the oxide particles used are more preferably aluminum oxide particles which preferably have a mean particle size of 0.1 to 10 μm, preferably of 0.1 to 5 μm. In addition, it is also possible to introduce lithium compounds into the ceramic dispersion, especially Li₂CO₃, LiCl, LiPF₆, LiBF₄, LiAsF₆, LiClO₄, LiTf (lithium trifluoromethyl-sulfonate), LiTFSl (lithium bis(trifluoromethane-sulfonylimide)), and they can thus be applied to the carrier substrate. Aluminum oxide particles in the range of the preferred particle sizes are supplied, for example, by Martinswerke under the designations MZS 3, MZS1, MDS 6 and DN 206, and by AlCoA under the names CT3000 SG, CL3000 SG, CL4400 FG, CT1200 SG, CT800SG and HVA SG.

To produce the solution, the organic binder, preferably the fluorinated organic binder, is dissolved in a solvent. The amount of the binder to be dissolved is determined by the abovementioned proportion of binder in the finished dispersion. The solvents used may be any compounds capable of dissolving the organic binder. The solvent used may, for example, be an organic compound selected from 1-methyl-2-pyrrolidone (NMP), acetone, ethanol, n-propanol, 2-propanol, n-butanol, cyclohexanol, diacetone alcohol, n-hexane, petroleum ether, cyclohexane, diethyl ether, dimethylformamide, dimethylacetamide, tetrahydrofuran, dioxane, dimethyl sulfoxide, benzene, toluene, xylene, dimethyl carbonate, ethyl acetate, chloroform or dichloromethane, or a mixture of these compounds. The solvent used is more preferably acetone, isopropanol and/or ethanol. It may be advantageous when the solution is produced with gentle heating, preferably to 30 to 55° C. The heating of the solvent can accelerate the dissolution of the binder.

The dispersion is preferably consolidated by removing the solvent. The solvent is preferably removed by evaporating (off) the solvent. The solvent can be removed at room temperature or at elevated temperature. The removal of the solvent at elevated temperature may be preferred when the solvent is to be removed rapidly. For ecological and/or economic reasons, it may be advantageous to collect the solvent removed by evaporation, to condense it and to use it again as the solvent in the process according to the invention.

In the process according to the invention, the dispersion can be applied to both sides or only to one side of the polymer film and consolidated there. If, to obtain a coating on both sides of the polymer film, the dispersion is applied to both sides of the polymer film and consolidated there, this can be accomplished in one step. However, it may also be advantageous when the dispersion is first applied to one side of the film and consolidated, and then the dispersion is applied to the other side of the film and consolidated.

In the process according to the invention, the dispersion can be applied to the polymer film, for example, by printing, pressing, impressing, rolling, knife coating, painting, dipping, spraying or casting. More preferably, especially when both sides of the polymer film are to be coated, the dispersion is applied by dipping the polymer film into the dispersion.

The process according to the invention for producing ceramic composite material can be performed, for example, by unrolling the polymer film from a roller with a speed of 1 m/h to 2 m/s, preferably with a speed of 0.5 m/min to 20 m/min, and it passing through at least one apparatus which applies the dispersion to one or two sides of the film and/or introduces it into the film, for example a roller, and at least one further apparatus which enables the consolidation of the dispersion, for example a (heated) fan, and the ceramic composite material thus produced being rolled onto a second roller. In this way, it is possible to produce the ceramic composite material in a continuous process. Any pretreatment steps necessary, for example the perforation of the film, can also be conducted in a continuous process with retention of the parameters mentioned.

The inventive ceramic composite materials, or the ceramic composite materials produced in accordance with the invention, can be used as ceramic composite materials in batteries, especially as ceramic composite materials in lithium batteries (lithium ion batteries), preferably high-performance and high-energy lithium batteries. In that case, they serve to insulate an anode from a cathode within an electrochemical cell.

The invention therefore also provides a ceramic composite material produced by the process according to the invention, and for the use of an inventive ceramic composite material for insulation of an anode from a cathode within an electrochemical cell.

The invention further provides the an electrochemical cell comprising an anode, a cathode, an electrolyte and an inventive ceramic composite material arranged between the anode and the cathode.

The electrochemical cell is preferably a lithium ion secondary battery.

The inventive ceramic composite materials can be used by simply placing them between the electrodes, or else by laminating a stack consisting of anode-ceramic composite material-cathode. Such lithium batteries may have, as electrolytes, for example, lithium salts with large anions in carbonates as the solvent. Suitable lithium salts are, for example, LiClO₄, LiBF₄, LiAsF₆ or LiPF₆, particular preference being given to LiPF₆. Organic carbonates suitable as solvents are, for example, ethylene carbonate, propylene carbonate, dimethyl carbonate, ethyl methyl carbonate or diethyl carbonate, or mixtures thereof.

Lithium batteries which have an inventive ceramic composite material can be used especially in fully electrically driven vehicles or vehicles with hybrid drive technology, for example fully electric cars, hybrid cars or electric bicycles, but also in portable electronic appliances such as laptops, cameras, cellphones, and in portable power tools.

The lithium batteries comprising the inventive ceramic composite material can likewise be used in stationary applications, such as off-grid stationary power supply with the aid of batteries (auxiliary power systems), in uninterrupted power supply and in the provision of balancing energy.

### WORKING EXAMPLES

The present invention will now be illustrated in detail with reference to the examples which follow, with the aid of the appended drawings, without the invention being restricted to the embodiments described. The figures show:

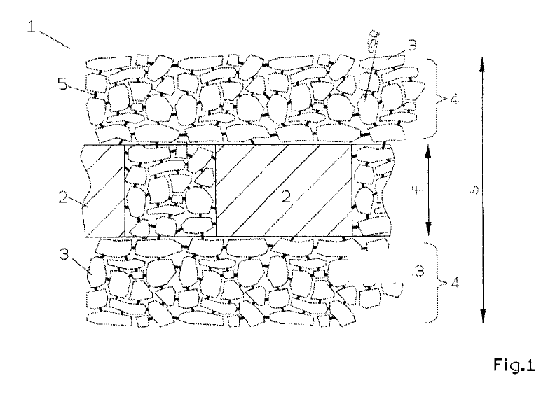

FIG. 1: inventive ceramic composite material in cross section;

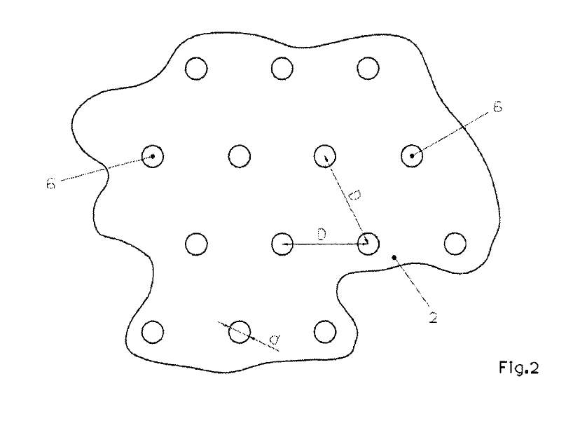

FIG. 2: hole pattern with offset holes;

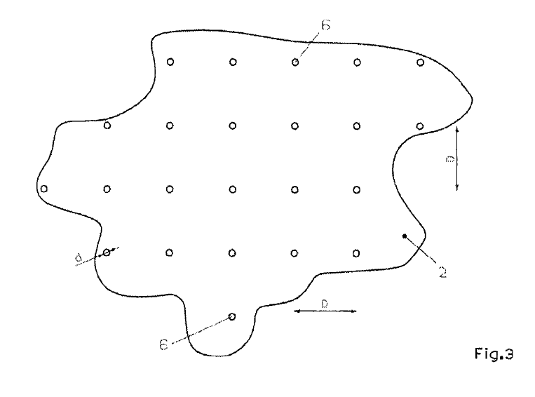

FIG. 3: hole pattern with aligned holes;

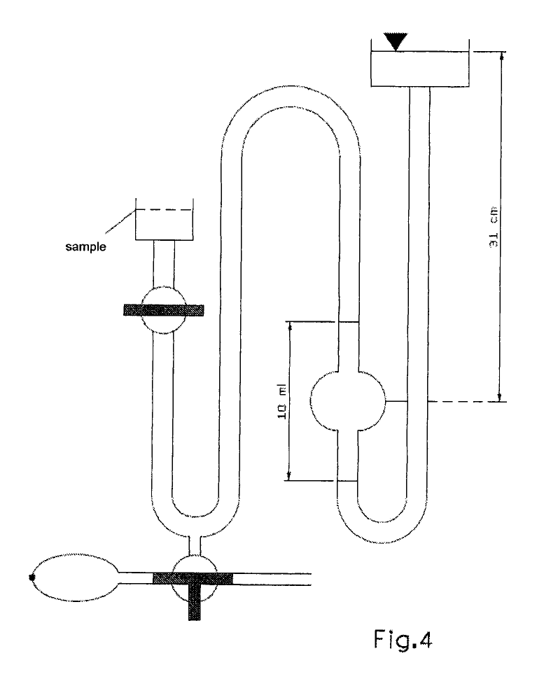

FIG. 4: Gurley apparatus;

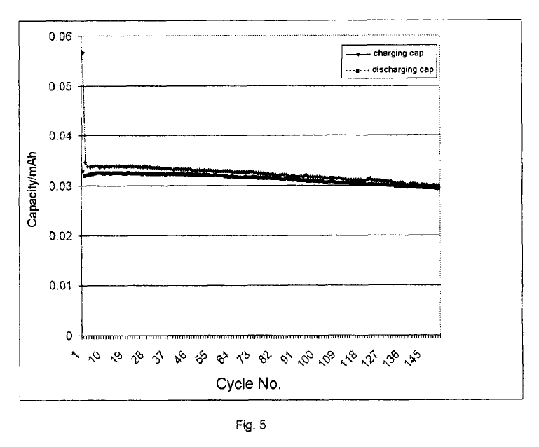

FIG. 5: diagram of charging characteristics;

Table 1: data of powder types.

FIG. 1 shows a schematic diagram of the cross section of an inventive ceramic composite material 1. The ceramic composite material 1 comprises a flat carrier substrate in the form of a polymer film 2 and a porous coating 4 which has ceramic particles 3 and has been applied to the carrier substrate (polymer film 2). The ceramic particles 3 are bonded to one another by means of a binder which forms bridges 5 between the particles 3. The polymer film 2 is provided with a perforation which consists of a multitude of regularly arranged holes 6. The holes 6 are through-holes. The coating 4 is arranged on both sides of the carrier substrate, such that the perforation of the polymer film 2 covers on both sides. Some of the particles 3 bonded to one another by means of the binder bridges 5 are in the holes 6, such that the coating 4 reaches through the holes 6 which form the perforation. The bridges 5 of the organic binder bonds not only the ceramic particles 3 to one another, but also some of the particles 3 to the organic perforated film 2.

In the schematic diagram of FIG. 1, the diameter d of the holes is 5 μm. The mean particle size d₅₀ is 1 μm. The thickness f of the film is 5 μm. Since the carrier substrate is coated on both sides with about five particle layers, the total thickness S of the ceramic composite material is only 15 μm.

FIG. 2 shows a perforated polymer film 2 in top view for the purpose of illustration of a first embodiment of the hole pattern in the context of the invention. The polymer film 2 has a multitude of circular holes 6, the totality of which forms a perforation. Each of the holes 6 has a uniform diameter d. The hole pattern is based on an equilateral triangle, with the holes arranged on the vertices thereof. The distance D between two adjacent holes 6, measured between the centers of the holes, is constant within the perforation. The holes 6 are arranged offset from one another.

FIG. 3 shows a perforated polymer film 2 in top view for the purpose of illustration of a second embodiment of the hole pattern in the context of the invention. The polymer film 2 has a multitude of circular holes 6, the totality of which forms a perforation. Each of the holes 6 has a uniform diameter d. The hole pattern is based on a square, with the holes arranged on the vertices thereof. The distance D between two adjacent holes 6, measured between the centers of the holes, is constant within the perforation. The holes are arranged in alignment in the plane. In this square embodiment, with a hole diameter of 5 μm, a hole distance D of 6.26 μm is selected in order to obtain a perforated area of 50%.

An inventive ceramic composite material can be produced as follows:

First, an unperforated PET polymer film is provided and perforated, such that the polymer film receives a perforation as shown in FIG. 2 or 3. A laser-supported process for perforation of the continuous polymer film is described in U.S. Pat. No. 7,083,837. Another suitable process is that filed by GR Advanced Materials Limited under the title “Microperforated Film” at the British Patent Office at the same time as the present application. Reference is made to the disclosure content of these publications. For example, it is possible to use a PET film from DuPont-Teijin Films (DTF) which has a thickness f of 1.7 μm and which has been perforated with holes having a diameter d of approx. 70 μm.

Then a slip is produced. For this purpose, a 10% by mass solution of a polyvinylidene fluoride-hexafluoro-propylene copolymer (PVdF-co-HFP) with a molar monomer ratio of 9 to 1, from Arkema, product name Kynar Flex 2801, is first produced in acetone. 3153 g of a 55% by mass mixture of aluminum oxide from Alcoa, product name CT3000, and acetone and 4 g of nitric acid are added while stirring to 4500 ml of this solution. The stirrer used is a paddle stirrer. For mixing, the mixture is stirred at 300 rpm for 1 hour. For further comminution of agglomerates, the mixture thus obtained is subjected to an ultrasound treatment (approx. 2 hours). For this purpose, the UP 400 S instrument from Hielscher can be used. The treatment is performed until no particles having a particle size of >10 μm are present in the slip. This can be ensured by filtering through a filter mesh of mesh size 10 μm, and evaporating the solvent, with subsequent visual checking.

It has been found that the use of commercial oxide particles leads to unsatisfactory results under some circumstances, since a very broad or polymodal particle size distribution is frequently present. Preference is therefore given to using metal oxide particles which have been classified by a conventional process, for example wind sifting and wet classification. The oxide particles used are preferably those fractions in which the coarse component, which makes up up to 10% of the total amount, has been removed by wet sieving. This troublesome coarse component, which can be comminuted only with very great difficulty, if at all, even by means of the processes which are typical in the production of the suspension, for instance grinding (ball mill, attritor mill, mortar mill), dispersing (Ultra-Turrax, ultrasound), trituration or chopping, may consist, for example, of aggregates, hard agglomerates, grinding ball attritus. The above measures achieve the effect that the coating has a very homogeneous pore size distribution.

Table 1 gives an overview of how the selection of the different aluminum oxides affects the porosity and the resulting pore size of the particular porous coating. To determine these data, the corresponding slips (suspensions or dispersions) were produced, and dried and consolidated as pure shaped bodies at 200° C.

TABLE 1
Typical data of ceramics as a function of the powder type used

| Al₂O₃ type | Porosity in % | Mean pore size in nm |
|---|---|---|
| AlCoA CL3000SG | 51 | 755 |
| AlCoA CT800SG | 53.1 | 820 |
| AlCoA HVA SG | 53.3 | 865 |
| AlCoA CL4400FG | 44.8 | 1015 |
| Martinsw. DN 206 | 42.9 | 1025 |
| Martinsw. MDS 6 | 40.8 | 605 |
| Martinsw. MZS 1 + | 47 | 445 |
| Martinsw. MZS 3 = 1:1 | | |
| Martinsw. MZS 3 | 48 | 690 |

The mean pore size and the porosity are understood to mean the mean pore size and the porosity which can be determined by the known method of mercury porosimetry, for example using a 4000 porosimeter from Carlo Erba Instruments. Mercury porosimetry is based on the Washburn equation (E. W. Washburn, “Note on a Method of Determining the Distribution of Pore Sizes in a Porous Material”, Proc. Natl. Acad. Sci., 7, 115-16 (1921)).

In the production of the ceramic dispersions, unsatisfactory results can be obtained under some circumstances. In that case, it may be advantageous to add dispersing aids (e.g. Dolapix CE64 from Zschimmer and Schwarz) and/or deaerators and/or defoamers and/or wetting agents (the latter three may, for example, be organically modified silicones, fluorosurfactants or polyethers which are obtainable, for example, from Evonik Degussa GmbH or TEGO) and/or silanes to the formulation, in order thus to achieve improved processability and, in the product, crosslinking of the ceramic. These silanes have the general formula

Rₓ—Si(OR)₄₋ₓ

where x=1 or 2 and R=an organic radical, optionally fluorinated organic radicals, where the R radicals may be the same or different, and the reactive hydroxyalkyl groups thereof are capable of reacting to form a covalent bond. Preferred silanes bear, for example, an amino group (3-aminopropyltriethoxysilane; AMEO), a glycidyl group (3-glycidyloxypropyltrimethoxysilane; GLYMO) or an unsaturated group (methacryloyloxypropyl-trimethoxysilane; MEMO) on the alkyl radical. In order to achieve a sufficient effect of the silanes, they can be added to the dispersion with a proportion of 0.1 to 20%, preferably of 0.5 to 5%.

It may be advantageous to treat the finished dispersion before application to the polymer film. For instance, it may especially be advantageous to treat the dispersion with ultrasound in order to break up any agglomerates formed and thus to ensure that only particles with the desired maximum particle size are present in the suspension. In any case, it is necessary to prevent settling or reagglomeration of the ceramic particles by stirring continuously.

The slip is then applied to the already perforated PET film which serves as the carrier substrate. The slip is applied to the film by manual dipping of the film into the slip. After the film has been pulled out of the slip, it is held vertically and allowed to drip dry. After excess slip has dripped off, the film coated with the slip is dried under air at room temperature for 12 hours.

A ceramic composite material produced in this way was analyzed:

Determination of the Gurley number: The Gurley number is a measure of the gas perviosity of a porous material. It is defined as the time required for 100 cm³ of air to diffuse through one inch² of a sample at a pressure of 12.2 inches or 30.988 cm of water column. A schematic diagram of the Gurley apparatus is shown in FIG. 4.

A cutting die (15 mm to DIN 7200) was first used to isolate a specimen from the ceramic composite material, and was installed into the Gurley apparatus: on the apparatus is an NS29 ground glass joint. To install the sample, the complete joint is removed from the apparatus. The first specimen is placed between the seal and screw thread. A joint clip is used to clamp the complete joint firmly onto the glass apparatus. Now bring the three-way tap on the apparatus into the correct position. The pressure ball is used to roughly adjust the meniscus of the ethylene glycol to the lower ring mark. Bring the three-way tap into the correct position and, with the aid of the venting valve, adjust it accurately to the ring mark.

Measurement procedure: Now the two-way tap at the ground glass joint is opened. As soon as the meniscus of the ethylene glycol passes the second ring mark, the stopwatch is started, and it is stopped at the third ring mark. The two-way tap has to be closed again. The measurement is repeated.

Calculation: The density of polyethylene glycol 400 is 1.113 g/cm³. The factor for the density correction is thus 0.885. The diameter of the membrane in the measurement is 1 cm. This gives an area of 0.785 cm³. Since the Gurley number is based on an area of the ceramic composite material of 1 inch², the time is divided by the area. In addition, instead of 100 cm³, only 10 cm³ is used as the measurement volume. Thus, the equation for the Gurley number is:

$$Gurley number = t [ \frac{10 {cm}^{3}}{{2.54}^{2} \cdot 0.785 [ {cm}^{2} ] \cdot 0.885} ]$$

In a first sample, as after the coating of the with the slip, a material was obtained which has a thickness S of 8 μm, a basis weight of 31 g/m² and a Gurley number of 73 seconds.

In a second sample, the film was additionally laminated onto a carrier nonwoven. After the coating with the slip, a material was obtained which has a thickness S of 20 μm, a basis weight of 52 g/m² and a Gurley number of 89 seconds.

The usability of the ceramic composite material produced as outlined was examined by building an electrochemical cell in the form of a flat-type lithium ion battery. The battery consisted of a positive material (LiCoO₂), a negative material (graphite) and an electrolyte composed of 1 mol/l LiPF₆ in ethylene carbonate/dimethyl carbonate (weight ratio 1:1). To produce the electrodes, positive material (3% carbon black (from Timcal, Super P), 3% PVdF (from Arkema, Kynar 761), 50% N-methylpyrrolidone) or negative material (1% carbon black (from Timcal, Super P), 4% PVdF (from Arkema, Kynar 761), 50% methylpyrrolidone) is applied by knife-coating in a layer thickness of 100 μm to aluminum foil (from Tokai, 20 μm) or copper foil (from Microhard, 15 μm) and dried to constant weight at 110° C. The two abovementioned samples were used as the ceramic composite material between the electrodes of the battery. Each battery ran stably over more than 100 cycles.

A diagram (capacity vs. charging/discharging cycle) of the charging performance is shown in FIG. 5.

### LIST OF REFERENCE NUMERALS

1 ceramic composite material
2 polymer film as carrier substrate
3 particle
4 coating
5 bridges of the binder
6 holes forming the perforation
d hole diameter
D distance between two adjacent holes
d₅₀ mean particle size
f thickness of the film
S thickness of the ceramic composite material

1: A ceramic composite material, comprising:
a) a flat carrier substrate; and
b) a porous coating on the flat carrier substrate comprising ceramic particles
wherein the carrier substrate is a polymer film having a perforation which comprises a multitude of regularly arranged holes, and
wherein the perforation is covered by the porous coating on at least one side of the carrier substrate.

2: The ceramic composite material of claim 1, wherein the holes are essentially round, and a distance between centers of two adjacent holes within the perforation is constant.

3: The ceramic composite material of claim 1, wherein the porous coating is on both sides of the carrier substrate, and the porous coating extends through the holes.

4: The ceramic composite material of claim 1, wherein the ceramic particles of the coating are bonded to one another with a binder, and wherein the binder is an inorganic compound.

5: The ceramic composite material of claim 4, wherein the binder comprises a silane.

6: The ceramic composite material of claim 1, wherein the ceramic particles of the coating are bonded to one another with a binder, and wherein the binder is an organic compound.

7: The ceramic composite material of claim 6, wherein at least some of the ceramic particles of the coating are bonded to the polymer film with the organic binder.

8: The ceramic composite material of claim 6, wherein the binder comprises a fluorinated polymer.

9: The ceramic composite material of claim 8, wherein the fluorinated polymer is polyvinylidene fluoride.

10: The ceramic composite material of claim 6, wherein the binder comprises a fluorinated copolymer.

11: The ceramic composite material of claim 10, wherein the fluorinated copolymer is polyvinylidene fluoride-hexafluoropropylene.

12: The ceramic composite material of claim 1, wherein the polymer film comprises at least one polymer selected from the group consisting of polyethylene terephthalate, polyacrylonitrile, polyester, polyamide, aromatic polyamide (aramid), polyolefin, polytetrafluoroethylene, polystyrene, polycarbonate, acrylonitrile-butadiene-styrene, and cellulose hydrate.

13: The ceramic composite material of claim 1, wherein the polymer film has a thickness of less than 25 μm.

14: The ceramic composite material of claim 2, wherein every hole of the perforation has a diameter of less than 500 μm.

15: The ceramic composite material of claim 1, wherein a proportion of the holes in a total area of the polymer film is from 10 to 90%.

16: The ceramic composite material of claim 1, wherein the ceramic particles have a mean particle size d₅₀ of 0.01 to 10 μm.

17: The ceramic composite material of claim 16, wherein the ceramic particles have a maximum particle size of 10 μm.

18: The ceramic composite material of claim 1, wherein the coating comprises ceramic particles which are oxides or mixed oxides of at least one element selected from the group consisting of lithium, boron, magnesium, aluminum, silicon, titanium, zinc, zirconium, niobium, barium, and hafnium.

19: A process for producing a ceramic composite material, the process comprising:
a) perforating a continuous polymer film such that the polymer film receives a perforation comprising a multitude of holes in regular arrangement, to obtain a perforated polymer film;
b) applying a porous coating comprising ceramic particles to at least one side of the perforated polymer film.

20: The process of claim 19, wherein the applying b) comprises applying a dispersion to the perforated polymer film and consolidating the dispersion, wherein the dispersion disperses ceramic particles in a solution, and
wherein the solution comprises an organic binder dissolved in an organic solvent.

21: The process of claim 20, wherein the dispersion has a proportion of 10 to 60% by mass of ceramic particles in an overall dispersion.

22: The process of claim 20, wherein the dispersion has a proportion of 0.5 to 20% by mass of an organic binder.

23: The process of claim 20, wherein the solvent comprises at least one organic compound selected from the group consisting of 1-methyl-2-pyrrolidone (NMP), acetone, ethanol, n-propanol, 2-propanol, n-butanol, cyclohexanol, diacetone alcohol, n-hexane, petroleum ether, cyclohexane, diethyl ether, dimethylformamide, dimethylacetamide, tetrahydrofuran, dioxane, dimethyl sulfoxide, benzene, toluene, xylene, dimethyl carbonate, ethyl acetate, chloroform, and dichloromethane.

24: The process of claim 20, wherein the dispersion is consolidated by removing the solvent.

25: The process of claim 20, wherein the dispersion is applied to both sides of the polymer film and introduced into the multitude of holes and consolidated.

26: The process of claim 25, wherein the dispersion is first applied to one side of the polymer film and introduced into the multitude of holes and consolidated, and then the dispersion is applied to the other side of the film and consolidated.

27: A ceramic composite material produced by the process of claim 19.

28: A method of insulating an anode from a cathode within an electrochemical cell, the method comprising:
contacting the ceramic composite material of claim 1 with an anode or a cathode.

29: An electrochemical cell comprising:
a cathode;
an anode;
an electrolyte; and
a ceramic composite material
wherein the ceramic composition is arranged between the cathode and the anode, and
wherein the ceramic composite material is the ceramic composite material of claim 1.

30: The electrochemical cell of claim 29, wherein the electrochemical cell is a lithium secondary battery.
